(19) United States
(12) Patent Application Publication
(10) Pub. No.: US 2008/0135524 A1
(43) Pub. Date: Jun. 12, 2008

(54) Arc Splitter for an Arcing Chamber

(75) Inventors: Volker Behrens, Bretten (DE); Thomas Honig, Pforzheim (DE)

Correspondence Address: Keith H Orum;ORUM & ROTH, Suite1616, 53 West Jackson Boulevard, Chicago, IL, 60604-3606, US

(73) Assignee: AMI DODUCO GMBH, Pforzheim (DE)

(21) Appl. No.: 11/658,326

(22) PCT Filed: Jul. 23, 2005
(86) PCT No.: PCT/EP05/08044

§ 371 Date: Feb. 28, 2007

(30) Foreign Application Priority Data
Jul. 24, 2004 (DE) 10 2004 036 113.4

(51) Int. Cl. H01H 9/36

(52) U.S. Cl. 218/150

(57) ABSTRACT

The invention relates to a coated arc splitter made of a ferromagnetic material for use in an arcing chamber. The invention provides that the arc splitter has a layer made of a composite material consisting of at least two constituents of which the first constituent is electrically conductive, has a melting point which does not exceed that of the ferromagnetic material, and has a vaporization point which does not exceed that of the ferromagnetic material, and of which the second component has a melting point higher than that of the first constituent, and has a vaporization point higher than that of the first constituent.

The present invention relates to coated arc splitters for arcing chutes in switching devices, especially in protective circuit-breakers. Arc splitters of that kind have been known from E. Vinaricky “Elektrische Kontakte, Werkstoffe und Anwendungen (Electric Contacts, Materials and Applications)”, Springer Verlag 2002, ISBN3-540-42431-8, pp. 134-142.

During opening and closing of electric circuits different electric discharge phenomena, depending on voltage and amperage, are encountered on the electric contacts. If voltage and amperage are high enough, the surface of the contact is subjected to arcing effects during each switching operation, which considerably influences the service life of the contact. The arcing effects lead to a loss in contact material (erosion). In the case of greater contact gaps, of the kind existing in protective circuit-breakers, the eroded contact material is predominantly lost to the environment. In order to keep such erosion of material low, one seeks to keep the dwelling time of the arc on the contact surfaces as short as possible. On closing, the burning time of the arc is determined mainly by the bounce time of the switching contacts and by the waveform of the making current. When breaking alternating currents, arcing continues below a critical current from the moment of opening to the next following zero crossing of the current wave; then self-extinguishing of the arc occurs.

Above a critical current, special measures have to be taken to extinguish the arc. It has been known for that purpose to cool or to split the arc. For that purpose, arcing chutes have been provided in the switching devices. Splitting arcs into partial arcs is effected in arcing chutes that contain an arrangement of arc splitters, according to the de-ionization principle. In an arcing chute operating, according to the de-ionization principle, a plurality of metal sheets, having a thickness of typically 1 mm, are provided in parallel or in fan-like arrangement and are insulated one relative to the other. Materials used for arc splitters are ferromagnetic materials because the magnetic field that accompanies the arc always endeavors, in the neighborhood of a ferromagnetic material, to flow through the arc splitters which have higher magnetic conductivity. This produces a sucking effect in the direction to the arc splitters. In addition to a magnetic blow field produced by the arc itself, that sucking action has the effect to move the arc toward the arc splitter arrangement and to split it between the latter.

It has been known to make the arc splitters from mild steel. In order to prevent overheating at the arc bases on the arc splitters and, thus, deteriorated cooling of the arc, one seeks to achieve high movability of the arc bases on the arc splitters. It has been known for that purpose to galvanically silver-plate or copper-plate the arc splitters. Still, local fusing of the material of the arc splitter, and spattering of the fused material, are encountered again and again under the effect of the arc. The risk of spattering exists because the arc is accompanied, like a lightning flash, by gas flows that may reach sound velocity and may manifest themselves in a bang. The rapid gas flows may entrain droplets of the molten iron. The droplets may short individual arc splitters making them ineffective. On the other hand, they may, however, also vagabond in the switching device and may settle, for example, on contact surfaces thereby increasing the contact resistance.

Now, it is the object of the present invention to reduce the disadvantages of known arcing chutes and to improve the service life and/or the short-circuit breaking capacity of switching devices equipped with such arcing chutes.

This object is achieved with the aid of arc splitters having the features defined in Claim 1. Advantageous methods for producing arc splitters according to the invention are defined in Claims 27 and 28.

Advantageous further developments of the invention are the subject-matter of the dependent claims.

Arc splitters according to the invention consist of a ferromagnetic base material and are coated. However, instead of being merely coated with one metal such as silver or copper, having a melting point which does not exceed that of the ferromagnetic material and, preferably, an electric conductivity higher than the latter, they are provided with a layer made from a composite material which, in addition to a first constituent having a melting point not exceeding that of the ferromagnetic material and a conductivity greater than that of the ferromagnetic material, has at least a second constituent having a melting point higher than that of the first constituent and also a vaporization point higher than that of the first constituent. The second constituent having the higher melting point, which will not fuse under the effect of the arc at the beginning, is intended to prevent spattering of the first, conductive or highly conductive constituent under the effect of the arc. The quantity and melting point of the second constituent are properly selected to achieve that effect.

Compared with the prior art, switching devices, which are provided with arcing chutes equipped with arc splitters according to the invention, distinguish themselves by longer service life and/or an improved short-circuit breaking capacity. The short-circuit breaking capacity is determined by the capability of protective circuit-breakers, being repeatedly closed in an electric circuit in which a short-circuit exists, to interrupt the electric circuit before a given current flow, defined by the value I²t (I=current intensity, t=break-time) is reached.

The electrically conductive or highly conductive first constituent is intended to favor moving of the arc on the arc splitters and to direct the electric current, which is transported by the arc, into the ferromagnetic material. The first constituent preferably is selected so that its vaporization point will likewise be reached under the effect of the arc, because vaporization of the first constituent will take so much energy from the arc that it will be interrupted.

The ferromagnetic base materials are not limited to mild steel, but may consist of any soft magnetic material, especially of nickel and cobalt as well as soft magnetic alloys of iron, nickel and cobalt.

The second constituent of the layer preferably is selected to permit effective binding of the first constituent to the arc splitter under the effect of the arc. Materials especially well suited for this purpose have a melting point higher than that of the ferromagnetic material and a vaporization point likewise higher than the vaporization point of the ferromagnetic material. Preferably, the melting point of the second constituent is even higher than the vaporization point of the first constituent. Especially well suited are the refractory metals tungsten, molybdenum and tantalum, as well as their carbides, nitrides and silicides, which may be used either in isolation or in combination.

The volume ratio between the first constituent and the second constituent conveniently is between 5:95 and 85:15, more conveniently between 30:70 and 80:20, even more conveniently between 40:60 and 70:30. Preferably, the first constituent makes up the greatest part.

Preferably, the composite layer further contains a third constituent selected from the group of oxides, carbides, borides and nitrides of the elements belonging to the main groups II, III, IV and VIII and to the subgroups III to VII of the periodic system of elements. Adding one or more substances of the third group improves the arc running behavior on the coated arc splitter so that the arc will move to an arc splitter arrangement in an arcing chute and will enter that arrangement, especially a package consisting of a plurality of arc splitters provided in parallel or in fan-like arrangement one relative to the other, more easily and more quickly.

Especially well suited as a third constituent of the composite material are substances selected from the group of titanium dioxide (TiO₂), aluminum oxide (Al₂O₃), magnesium oxide (MgO), manganese oxide (MnO), niobium oxide (NbO), nickel oxide (NiO), cerium oxide (CeO₂), chromium oxide (Cr₂O₃), lanthanum oxide (La₂O₃), zirconium oxide (ZrO), Yttrium oxide (Y₂O₃), boric carbide (B₄C), silicon carbide (SiC), zirconium carbide (ZrC), aluminum nitride (AlN), boric nitride (BN), titanium nitride (TiN), titanium boride (TiB₂) and zirconium boride (ZrB₂). Aluminum oxide and magnesium oxide are especially preferred.

The third constituent is provided in the composite material preferably to the charge of the second constituent. The volume ratio between the first constituent and the sum of the second and the third constituents therefore conveniently lies between 5:95 and 85:15, more conveniently between 30:70 and 80:20, most conveniently between 40:60 and 70:30. Preferably, the part of the first constituent is greater than the sum of the second and the third constituents in this case as well.

The layer made from the composite material preferably has a thickness of between 0.05 mm and 0.3 mm, preferably of approximately 0.1 mm. It may be applied by rolling a strip of the composite material onto a ferromagnetic strip, especially by hot-roll plating. Another possibility consists in applying the constituents of the layer upon a ferromagnetic sheet by thermal spraying (flame spraying), in which case the coating preferably is compressed and leveled by rolling.

In order to form from the composite material an arc splitter having a layer according to the invention, it is not necessary that all the constituents of the composite material be applied onto, and bonded to, the sheet of the ferromagnetic material. Instead, there is also the possibility to apply one of the constituents, especially the second constituent, preferably also the third constituent, if provided, onto the sheet in the form of a powder and to roll it into the surface of the ferromagnetic sheet so that the material of the ferromagnetic sheet becomes part of the composite material over a surface layer which is characterized by the depth of penetration of the rolled-in particles. For example, a tungsten carbide powder may be applied onto a mild steel sheet and a composite layer consisting of iron and tungsten carbide may be formed by pressing the particles of the tungsten carbide powder into the surface of the mild steel by cold rolling.

Preferably, one further provides between the composite layer and the ferromagnetic base material an intermediate layer that improves the bonding effect and obstructs diffusion. A material particularly well suited for this purpose is nickel, which further provides the advantage to be ferromagnetic. The intermediate layer preferably is applied galvanically, conveniently in a thickness of between 3 μm and 20 μm, especially of approximately 10 μm.

### EXAMPLES

1. A composite layer of 0.25 mm thickness, consisting of 70 percent by volume of copper and 30 percent by volume of tungsten, is applied by thermal spraying onto a mild steel sheet having a thickness of 1 mm. After application, the layer is compressed by cold rolling. The arc splitter so produced may be shaped by bending and punching and may be installed in a low-voltage switching device.

2. A strip consisting of 55 percent by volume of silver and 45 percent by volume of molybdenum is plated by cold-roll plating upon a ferromagnetic strip made from an iron-cobalt alloy. After cold-rolling, the arc splitter has a thickness of 1 mm, the composite layer of silver-molybdenum being 0.1 mm thick. The arc splitter so produced may be shaped by bending and punching and may be installed in a low-voltage switching device.

3. A mild steel sheet of 1 mm thickness is initially provided with a nickel layer of 10 μm thickness by a galvanic process, whereafter a composite layer of 0.2 mm thickness, consisting of 40 percent by volume of copper and 60 percent by volume of tungsten carbide, is applied by fusing. The sheet so obtained is formed into an arc splitter by bending and punching and is installed into a low-voltage switching device.

4. A strip consisting of a ferromagnetic iron-nickel alloy is coated by hot-roll plating with a strip made from a composite material consisting of 50 percent by volume of silver and 50 percent by volume of tantalum. After hot-roll plating, the thickness of the strip is 1.2 mm, the thickness of the composite layer consisting of silver and tantalum being 0.15 mm. The strip is formed into arc splitters by bending and punching and is installed into a low-voltage switching device.

5. A tungsten carbide powder is applied onto a mild steel sheet having a thickness of 1.2 mm and is pressed into the surface of the mild steel by cold rolling. The quantity of powder applied onto the mild steel is such that the latter will still form between 50 percent and 60 percent of the surface of the arc splitter. One thus obtains a functional layer consisting of iron and tungsten carbide on the surface of the mild steel. The sheet so produced may be formed into an arc splitter by bending and punching and may be installed in a low-voltage switching device.

6. A mixture of 70 parts by volume of tungsten carbide powder and 30 parts by volume of aluminum oxide powder is spread upon a mild steel sheet having a thickness of 1.2 mm, and is pressed into the surface of the mild steel by cold rolling. The quantity of powder applied onto the mild steel is such that the latter will still form between 50 percent and 60 percent of the surface of the arc splitter. One thus obtains a functional layer consisting of iron, aluminum oxide and tungsten carbide on the surface of the mild steel. The sheet so produced may be formed into an arc splitter by bending and punching and may be installed in a low-voltage switching device.

1. Coated arc splitter made of a sheet of a ferromagnetic material for use in an arcing chute, wherein the arc splitter has a layer made of a composite material consisting of at least two constituents of which the first constituent is electrically conductive, has a melting point which does not exceed that of the ferromagnetic material, and has a vaporization point which does not exceed that of the ferromagnetic material, and of which the second constituent has a melting point higher than that of the first constituent, and has a vaporization point higher than that of the first constituent.

2. The arc splitter as defined in claim 1, wherein the melting point of the second constituent is higher than the melting point of the ferromagnetic material and that the vaporization point of the second constituent is higher than the vaporization point of the ferromagnetic material.

3. The arc splitter as defined in claim 1, wherein the melting point of the second constituent is higher than the vaporization point of the first constituent.

4. The arc splitter as defined in claim 1 wherein the volume ratio between the first constituent and the second constituent is between 5:95 and 85:15.

5. The arc splitter as defined in claim 1 wherein the volume ratio between the first constituent and the second constituent is between 30:70 and 80:20.

6. The arc splitter as defined in claim 1 wherein the volume ratio between the first constituent and the second constituent is between 40:60 and 70:30.

7. The arc splitter as defined in claim 1 wherein the volume ratio between the first constituent and the second constituent is greater than 1.

8. The arc splitter as defined in claim 1, wherein the thickness of the layer made from the composite material is 0.05 mm to 0.3 mm, preferably approximately 0.1 mm.

9. The arc splitter as defined in claim 1, wherein the layer made from the composite material contains particles of the first constituent and/or particles of the second constituent in sizes up to the thickness of the layer made from the composite material.

10. The arc splitter as defined in claim 1, wherein it has a thickness of 0.5 mm to 2 mm, especially of 0.8 mm to 1.2 mm.

11. The arc splitter as defined in claim 1, wherein the first constituent consists of silver or copper or alloys of those materials.

12. The arc splitter as defined in claim 1, wherein the first constituent is a ferromagnetic material.

13. The arc splitter as defined in claim 1, wherein the second constituent consists of tungsten, molybdenum and/or tantalum and/or carbides, nitrides and silicides of those materials.

14. The arc splitter as defined in claim 1, wherein at least one intermediate layer is provided between the composite material and the ferromagnetic material present below the latter.

15. The arc splitter as defined in claim 14, wherein the intermediate layer is selected to obstruct diffusion.

16. The arc splitter as defined in claim 14 wherein the intermediate layer is ferromagnetic and consists especially of nickel.

17. The arc splitter as defined in claim 14, wherein the intermediate layer has a thickness of between 3 μm and 20 μm, especially of 10 μm.

18. The arc splitter as defined in claim 14, wherein the intermediate layer is applied galvanically.

19. The arc splitter as defined in claim 1, wherein the layer made from the composite material is provided on both sides of the ferromagnetic material.

20. The arc splitter as defined in any of the preceding claims, claim 1, wherein the composite material comprises a third constituent which contains one or more substances selected from the group of oxides, carbides, borides and nitrides of the elements belonging to the main groups II, III, IV and VIII and to the subgroups III to VII of the periodic system of elements.

21. The arc splitter as defined in claim 20, wherein the part of the third constituent in the composite material is 0.3 percent by volume to 20 percent by volume of the composite material.

22. The arc splitter as defined in claim 20 wherein the volume ratio between the first constituent and the sum of the second and the third constituents is between 9:95 and 85:15.

23. The arc splitter as defined in claim 20 wherein the volume ratio between the first constituent and the sum of the second and the third constituents is between 30:70 and 80:20.

24. The arc splitter as defined in claim 20 wherein the volume ratio between the first constituent and the sum of the second and the third constituents is between 40:60 and 70:30.

25. The arc splitter as defined in claim 20 wherein the volume ratio between the first constituent and the sum of the other constituents is greater than 1.

26. The arc splitter as defined in claim 20, wherein the third constituent is selected from the group of titanium dioxide (TiO₂), aluminum oxide (Al₂O₃), magnesium oxide (MgO), manganese oxide (MnO), niobium oxide (NbO), nickel oxide (NiO), cerium oxide (CeO₂), chromium oxide (Cr₂O₃), lanthanum oxide (La₂O₃), zirconium oxide (ZrO), yttrium oxide (Y₂O₃), boric carbide (B₄C), silicon carbide (SiC), zirconium carbide (ZrC), aluminum nitride (AlN), boric nitride (BN), titanium nitride (TiN), titanium boride (TiB₂) and zirconium boride (ZrB₂), aluminum oxide and magnesium oxide being especially preferred.

27. A method for producing an arc splitter according to claim 1, wherein the layer made from the composite material is applied by roll-plating or by thermal spraying, to the ferromagnetic sheet material.

28. A method for producing an arc splitter according to claim 1, wherein the first constituent and/or the second constituent and/or the third constituent are applied onto the sheet in the form of a powder and are rolled into the ferromagnetic sheet material present underneath.

29. The method as defined in claim 28, wherein only the second constituent of the layer is applied onto, and rolled into, the ferromagnetic sheet.

30. The method as defined in claim 29, wherein a third constituent of the layer, if any, is likewise applied onto, and rolled into, the ferromagnetic sheet.

31. The method as defined in claim 30, wherein the second and the third constituents are jointly applied onto, and are rolled into, the sheet.

32. The method as defined in claim 27, wherein the sheet is cold-rolled.
